(19) United States
(12) Patent Application Publication
(10) Pub. No.: US 2019/0302868 A1
(43) Pub. Date: Oct. 3, 2019

(54) Remote Power Management Module

(71) Applicants: Mark R. Gregorek, Mahwah, NJ (US); Arthur Charych, Setauket, NY (US)

(72) Inventors: Mark R. Gregorek, Mahwah, NJ (US); Arthur Charych, Setauket, NY (US)

(21) Appl. No.: 16/380,991

(22) Filed: Apr. 10, 2019

Related U.S. Application Data
(63) Continuation-in-part of application No. 15/695,926, filed on Sep. 5, 2017, now abandoned.
(60) Provisional application No. 62/384,122, filed on Sep. 6, 2016.
(60) Provisional application No. 62/510,235, filed on May 23, 2017.

(51) Int. Cl. G06F 1/3209; G06F 1/3246; H05B 39/04

(52) U.S. Cl. CPC G06F 1/3209; H05B 41/3924; H05B 39/042; G06F 1/3246

(57) ABSTRACT

A power control device is provided for adjusting the input power to a device. The power control device includes an input, an output, and two or more output levels. A device such as an electrical device, appliance, or tool is attached to the output of the power control device. Further, a switch couples the input of the power control device to a power source. Thereby, the output level of the power control device can be adjusted by turning on and turning off the power source within a period of time.

### CROSS-REFERENCE TO RELATED APPLICATION

This application claims priority to U.S. patent application Ser. No. 15/695,926, filed Sep. 5, 2017, and entitled “Remote Power Management Module,” claims priority to U.S. Provisional Application No. 62/510,235, filed on May 23, 2017, and entitled “Remote Power Management Module (RPMM),” and claims priority to U.S. Provisional Application Ser. No. 62/384,122, filed on Sep. 6, 2016, and entitled “Remote Power Management Module (RPMM),” and which are hereby incorporated by reference herein in their entirety, including any figures, tables, equations or drawings.

### TECHNICAL FIELD

The system and methods disclosed herein relate to power management, and more particularly, to controlling the power input into a device.

### BACKGROUND

A common method of adjusting the power input into a device is the use of variable resistors, such as a rheostat and potentiometer, while a step-down transformer allows for a device with a low power input rating to be compatible with a high power supply greater than what the device is designed for. Typically, a variable resistor includes a resistive track and a wiper terminal. One end of the resistive track of the variable resistor and its wiper terminal are connected to a circuit. As a result, the variable resistor can limit the current in the circuit according to the position of the wiper. Variable resistors are generally used in tuning circuits and power control applications. Such devices are considered “linear” devices, because the power output from the variable resistor can be varied incrementally. A variable resistor may also be employed when an appliance is connected to or within a circuit having an attached power supply that is either fully on or off.

A step down transformer transfers electrical energy between two or more circuits through electromagnetic induction. Typically, the primary windings of the step-down transformer is attached to a high alternating current (AC) source which is reduced in the secondary windings based on the ratio of turns between the primary windings and the secondary windings. A low AC power device is attached to the secondary windings of the step-down transformer.

An inherent disadvantage in known variable resistors and step-down transformers is the need for various mechanical components that can potentially fail. Further, difficulties exist in adjusting the variable resistors to a specific power output, due to the incremental adjustment and in some cases the need for the full “linear” range is not necessary.

Therefore, there is a need in the art for a power management system that can be set to pre-determined output levels.

Conventional lamp dimmers utilize an input device to adjust the dimming of a lamp. The dimming adjustment can be a potentiometer or multi-position switch which is part of the dimmer. Furthermore, the dimming adjustment can be a Touch Sensor, a RF (Radio Frequency) signal, a Bluetooth Signal, an IR (Infrared Radiation) Signal, or any other device or function that is used to adjust the amount of dimming desired. An inherent disadvantage not addressed by conventional lamp dimmers is the need for a diming input to adjust the output level of the lamp. Adjustments that are part of the dimmer are not practical for dimmers and lamps mounted on a ceiling, due to the accessibility issues for users. Therefore, a dimming device is typically installed by a licensed electrician to replace existing wall mounted on/off switches in accordance with building codes. To the extent that a user attempts to replace an existing switch, the user risks exposing themselves to injury from improperly disconnected wires. Further, the user can improperly connect the wiring when replacing the switch, thereby creating electrical issues. Also, the dimming device can be cost prohibitive, for example, dimmer devices with remote control capability. Furthermore, a replacement dimmer switch can conflict with the aesthetics of the area that the existing switch is located, for example in a historical building.

Therefore, there is a need in the art for a power management system that can be utilized with existing wall mounted on/off switches to adjust the dimming level of a lamp without the need to install a wall mounted dimmer switch or a remote control device.

### SUMMARY

The Remote Power Management Module (RPMM) disclosed herein is a controllable, multi-stage power supply modulator that has a plurality of output levels. In the preferred embodiment, the RPMM has more than two (2) and less than five (5) pre-set output levels from the input power of the RPMM. The pre-set levels are preferably established based on the desired use. As a result, the RPMM can adjust the power input into a device attached to the RPMM similar to the functions of a rheostat and potentiometer, without the use of a variable resistor terminal.

In some embodiments, the RPMM can adjust the power input into a device attached to the RPMM similar to a step-down transformer, without the need of a core or windings. It is well-known in the art that household, hobby, and workforce related appliances, such as electrical devices and tools have variable speed/power settings. The variable control dial or rocker arm for low, medium, and high settings utilize rheostats and potentiometers located physically in the tool, electrical device, or appliance. The benefits of the principles disclosed herein are readily apparent as the RPMM exhibits a plurality of output levels, which can be configured to correspond to low, medium, and high-speed settings for a tool, electrical device, or appliance.

In some embodiments, the RPMM is a separate component from the tool, electrical device, or appliance, thereby improving the ease of manufacturing said tool, electrical device, or appliance, because configuring the speed setting is controlled by the RPMM. In addition, the principles disclosed herein further allow for the acceptance of various tools, electrical devices, or appliances that do not contain power modulation components.

In some embodiments, the RPMM is activated by the power supply that is utilized. In addition to having a plurality of preset output levels, the power supply modulator can include more advanced modulating systems such as a microprocessor, switch, resistor, or any similar components capable of regulating the output level.

Furthermore, the RPMM disclosed in accordance with the principles disclosed herein can be configured to remove the need for an additional dimming input to adjust the output level of a lamp coupled to a ceiling fixture. The RPMM utilizes existing wall mounted on/off switches for adjusting the output level of a dimmer attached to a ceiling fixture. In one embodiment, a dimmer is coupled to a ceiling fixture comprising the RPMM. A lamp is coupled to the output of the RPMM. Thereafter, the dimming of the lamp is configured by turning on and turning off the existing switch. In addition, the RPMM can be manufactured integrated with the lamp. Therefore, the integrated RPMM and lamp can be attached to a conventional ceiling fixture.

### BRIEF DESCRIPTION OF THE DRAWINGS

The detailed description makes reference to the accompanying figures wherein:

FIG. 1 illustrates a block diagram of a prior art light dimmer circuit;

FIG. 2 illustrates a block diagram depicting a power control device in accordance with the principles disclosed herein;

FIG. 3 illustrates a block diagram depicting a power control device circuit in accordance with the principles disclosed herein;

FIG. 4 illustrates a block diagram depicting a controller power supply circuit in accordance with the principles disclosed herein;

FIG. 5 illustrates a block diagram depicting a power control device circuit for a LED lamp in accordance with the principles disclosed herein;

FIG. 6 illustrates a flowchart in accordance with the principles disclosed herein;

FIG. 7 illustrates a flowchart in accordance with the principles disclosed herein; and

FIG. 8 illustrates a flowchart in accordance with the principles disclosed herein.

Other objects, features, and characteristics of the broad inventive concepts, as well as methods of operation and functions of the related elements of the structure and the combination of parts, will become more apparent upon consideration of the following detailed description with reference to the accompanying drawings.

### DETAILED DESCRIPTION OF THE PREFERRED EMBODIMENT

A detailed illustrative embodiment of the broad inventive concepts is disclosed herein. However, techniques, methods, processes, systems, and operating structures may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, electronic or otherwise, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list. The following presents a detailed description with reference to the figures.

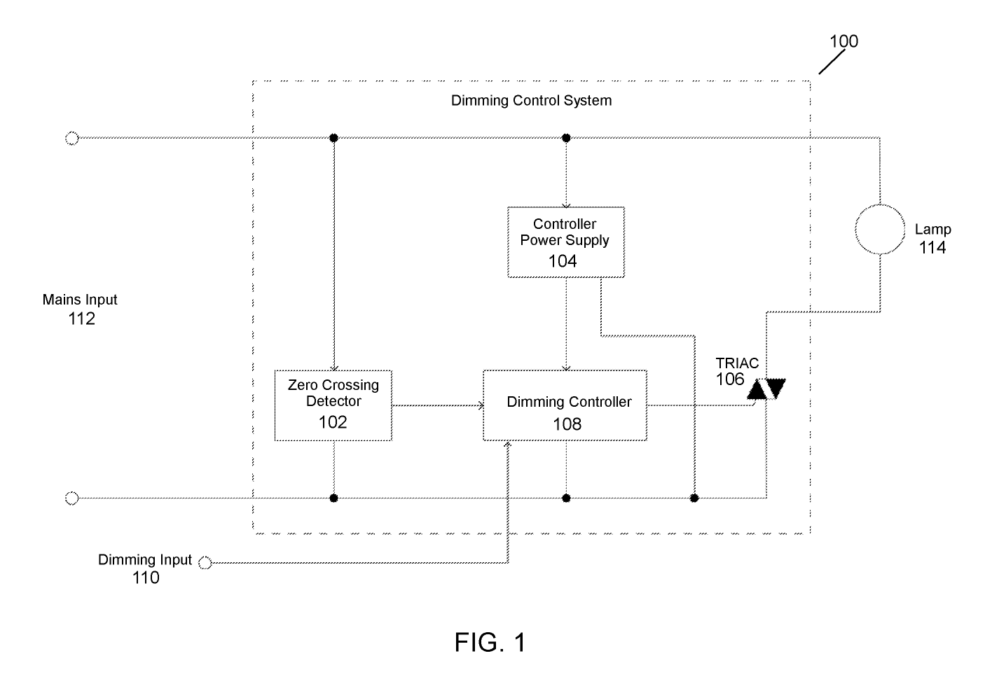

Referring initially to FIG. 1, shown is a block diagram of an existing light dimmer circuit. Dimming control system 100 is coupled to mains input 112 and lamp 114. As shown, dimming control system 100 comprises zero crossing detector 102, controller power supply 104, TRIAC 106, and dimming controller 108. Zero crossing detector 102 is coupled to dimming controller 108 and configured to transmit a signal when zero crossing detector 102 detects an AC waveform of mains input 112 crosses through zero volts. Mains input 112 can be configured to be 115 VAC to 230 VAC. Dimming controller 108 is configured to trigger TRIAC 106 after receiving a signal from zero crossing detector 102 and a predetermined delay. Further, TRIAC 106 is configured to turn off after mains input 112 crosses zero volts. Thereafter, TRIAC 106 is configured to remain off until receiving a trigger from dimming controller 108. As shown in FIG. 1, lamp 114 is coupled in series with TRIAC 106. The length of time that dimming controller 108 delays to turn on TRIAC 106 is configured to adjust the output level of lamp 114.

The output level, and in turn the intensity of lamp 114, is configured by dimming input 110. Dimming input 110 is coupled to dimming controller 108. Dimming input 110 can be a potentiometer, a switch, a Touch Sensor, a Radio Frequency (RF) Signal, a Bluetooth Signal, an Infrared radiation (IR) Signal, or any other device or function that is configured to adjust the length of time that dimming controller 108 delays prior to turning on TRIAC 106.

A problem not addressed by existing light dimmer circuits is the need for a dimming input to adjust the output level of the lamp. Adjustments that are part of the dimming controller are not practical for dimming controllers and lamps mounted on a ceiling, due to the accessibility for users. Therefore, the dimming input is typically installed by a licensed electrician to replace existing wall mounted on/off switches or a much more expensive dimmer with remote control capability in accordance with building codes.

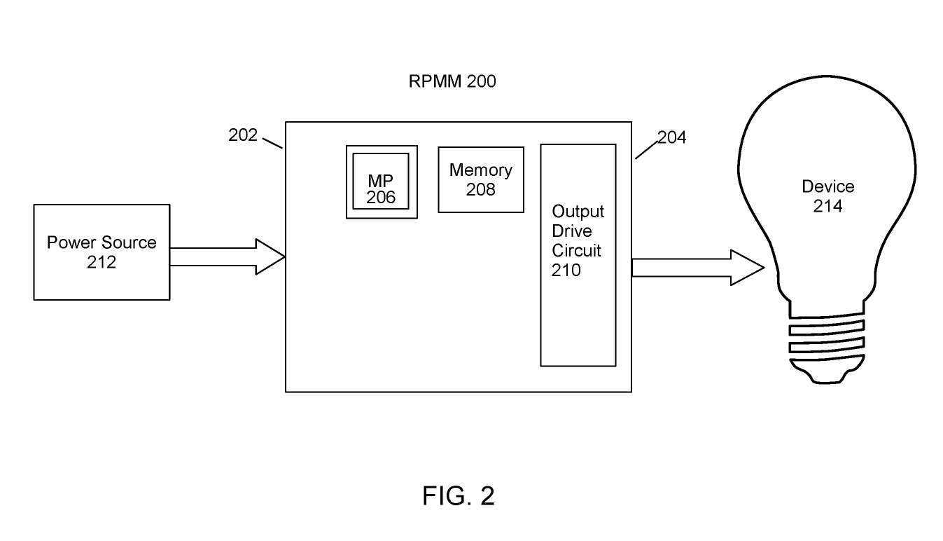

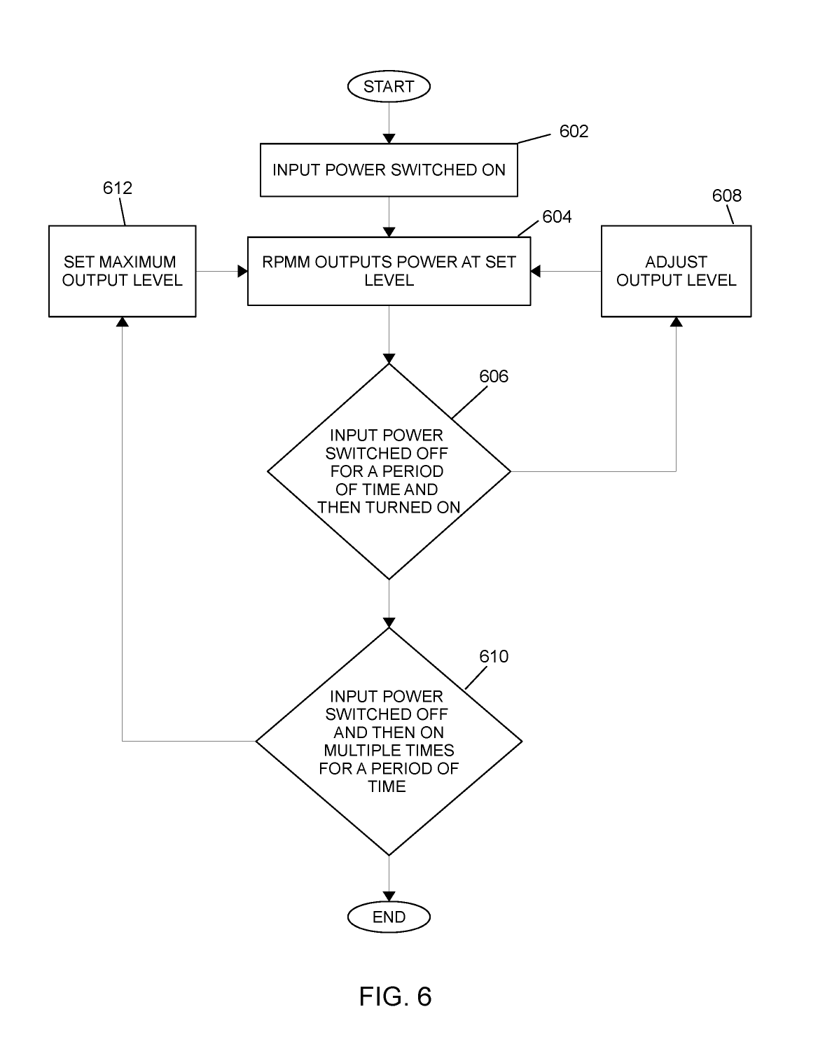

Referring now to FIG. 2, shown is an exemplary block diagram of a remote power management module (RPMM) in accordance with the principles disclosed herein. RPMM 200 comprises input 202 and output 204. In the preferred embodiment, power source 212 is coupled to input 202. Power source 212 can comprise a single phase or three phase alternating current (AC) source, or a direct current (DC) source. Further, power source 212 can include an internal switch or an external switch coupled between power source 212 and input 202. The switch is configured to turn on and turn off the output power of power source 212 transmitted to RPMM 200. RPMM 200 further comprises microprocessor 206 and memory 208. The configuration of the output level of RPMM 200 is stored in memory 208. In some embodiments memory 208 is read-only memory (ROM) or erasable programmable read-only memory (EPROM). In the preferred embodiment, the configuration of the output levels stored in memory 208 comprises 30 Volts (V), 60 V, and 120 V. As described in detail below with reference to FIGS. 6-8, the output level of output 204 is selected by a sequence of turning on and turning off the power to input 202 utilizing a switch. For example, the output level of output 204 can be initially set to 30 V. Thereafter, the output level can be set to 60 V by a sequence of turning on and turning off the power to input 202. The sequence of turning on and turning off the power to input 202 can be performed again to set the output level to 120 V. Furthermore, the output level can be set to 30 V by repeating the sequence of turning on and turning off the power to input 202. As a result, the output level cycles through the plurality of output levels stored in memory 208. In one embodiment, the RPMM includes a Bluetooth controller. In this embodiment, the Bluetooth controller allows configuration of the plurality of output levels and/or the output level of the RPMM utilizing Bluetooth communication. It would be readily apparent to one of ordinary skill in the art to utilize various other communication methods, such as a wireless local area network (LAN) to configure and/or control the output of the RPMM, without departing from the principles disclosed herein.

Microprocessor 206 controls output drive circuit 210 to set the output level of output 204. In one embodiment, the microprocessor can include hardware in order to continue operating when the power from the power source attached to the input of the RPMM is turned off. Exemplary hardware includes but is not limited to an internal battery, which can be charged when the power from the power source attached to the input of the RPMM is turned on. Furthermore, a holdup circuit can be used that allows the microprocessor to operate for a period of time after the power source is disconnected from the input of the RPMM. In an embodiment where the power source is an AC source, the output drive circuit can comprise a semiconductor switch, for example a thyristor, positioned in series between the AC source and the device attached to the output of the RPMM. Thereby, the microprocessor configures the output level of the RPMM by controlling when the semiconductor switch is conductive or nonconductive for portions of the cycle of the AC source. It would be apparent to one of ordinary skill in the art to utilize other circuits to control the output level from an AC source, without departing from the principles disclosed herein. In an embodiment where the power source is a DC source, the output drive circuit can comprise a switch mode circuit, for example a buck-boost regulator. Thereby, the microprocessor can control the output level by adjusting the duty cycle of the switch mode circuit.

As shown in FIG. 2, device 214 is coupled to output 204 of RPMM 200. Device 214 is shown as a light fixture, which can be configured to receive an incandescent, compact fluorescent (CFL), light emitting diode (LED), or Halogen bulb. Thereby, RPMM 200 can vary the intensity of a bulb attached to the light fixture by adjusting the output level of output 204. In some embodiments, the RPMM is integrated into the light fixture. It would be apparent to one of ordinary skill in the art to couple any appliance, tool or device to output 204 of RPMM 200, without departing from the principles disclosed herein.

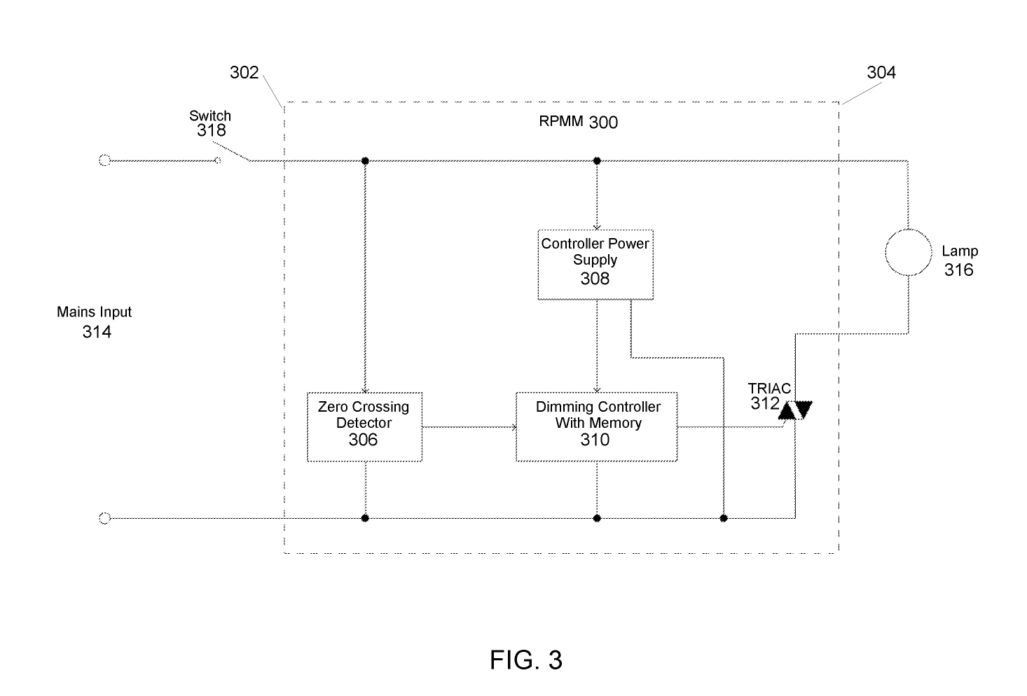

Shown in FIG. 3 is another exemplary block diagram of a RPMM in accordance with the principles disclosed herein. RPMM 300 comprises input 302 and output 304. Mains input 314 and lamp 316 are coupled in parallel to input 302 and output 304, respectively. Although RPMM 300 is shown as a separate device from lamp 316, it would be apparent to one of ordinary skill in the art to integrate the RPMM into lamp 316 without departing from the principles disclosed. In this exemplary embodiment, switch 318 is configured to adjust the output level of output 304. As described in detail below with reference to FIGS. 6-8, the output level of output 304 is selected by a sequence of turning on and turning off switch 318, thereby turning on and turning off the power to input 302 from mains input 314. For example, the output level of RPMM 300 can be initially set to 30 V. Thereafter, the output level can be set to 60 V by a sequence of turning on and turning off switch 318. The sequence of turning on and turning off switch 318 can be performed again to set the output level to 120 V. Furthermore, the output level can be set to 30V by repeating the sequence of turning on and turning off switch 318. As a result, the output level cycles through the plurality of output levels stored on RPMM 300. In this embodiment, switch 318 is an existing wall switch. Therefore, a user can add dimming control functionality to an existing wall switch in accordance with the principles disclosed herein without the need to hire an electrician to replace the existing wall switch. Furthermore, switch 318 replaces the dimmer input shown in FIG. 1.

RPMM 300 further comprises zero crossing detector 306, controller power supply 308, dimming controller 310, and TRIAC 312. Zero crossing detector 306 is coupled to dimming controller 310 and configured to transmit a signal when zero crossing detector 306 detects an AC waveform of mains input 314 crosses through zero volts. Mains input 314 can be configured to be 115 VAC to 230 VAC. Dimming controller 310 is configured to trigger TRIAC 312 after receiving a signal from zero crossing detector 306 and a predetermined delay. Further, TRIAC 312 is configured to turn off after mains input 314 crosses zero volts. Thereafter, TRIAC 312 is configured to remain off until receiving a trigger from dimming controller 310. As shown in FIG. 3, lamp 316 is coupled in series with TRIAC 312. The length of time that dimming controller 310 delays to turn on TRIAC 312 is configured to adjust the output level of lamp 114. Dimming controller 310 comprises a microprocessor and non-volatile memory. The non-volatile memory of dimming controller 310 is configured to store program code that is executed by the microprocessor. The program code comprises instructions to determine the predetermined delay to turn on TRIAC 312 to a specific output level. Further, the non-volatile memory of dimming controller 310 is configured to store a plurality of output levels for output 304 of RPMM 300.

In this embodiment, controller power supply 308 is configured to regulate the voltage level across input 302 of RPMM 300 to a voltage level that dimming controller 310 can operate. An exemplary voltage level is 5 Volt Direct Current (VDC). It would be apparent to one of ordinary skill that the controller power supply can output 3.3 VDC, 9 VDC, or 12 VDC, without departing from the principles disclosed herein. Furthermore, controller power supply 308 is configured to provide power to dimming controller 310 for at least five seconds after mains input 314 is removed by turning off switch 318. Thereby, dimming controller 310 can operate while mains input 314 is disconnected from input 302 of RPMM 300. As a result, dimming controller 310 can configure the desired output level of output 304 by a sequence of turning on and turning off switch 318.

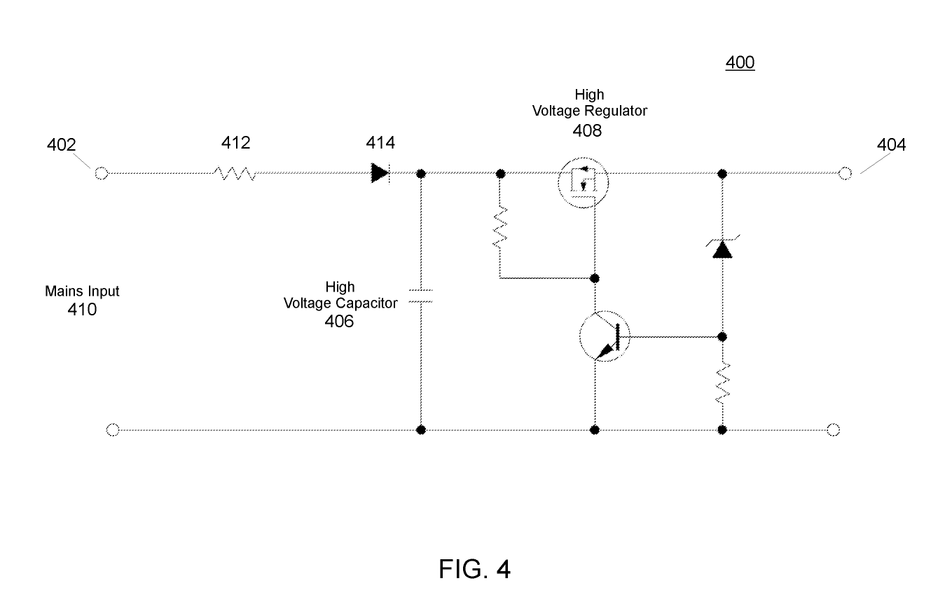

FIG. 4 depicts an exemplary circuit diagram 400 of a controller power supply in accordance with the principles disclosed herein. Circuit diagram 400 comprises input 402, output 404, high voltage capacitor 406, and high voltage regulator 408. Mains input 410 is coupled to input 402 and can be configured to be 115 VAC to 230 VAC. As shown in FIG. 4, high voltage capacitor 406 is coupled in parallel to input 402 and in series with resistor 412 and diode 414. As a result, high voltage capacitor 406 is configured to charge to the voltage level across input 402 as current flows from input 402 through high voltage capacitor 406. The charging current approaches zero as high voltage capacitor 406 is charged to the voltage level across input 402 (in this example the voltage of mains input 410). Further, high voltage capacitor 406 is configured to store energy to allow a dimming controller (not shown) coupled to output 404 to operate for at least five seconds after mains input 410 is removed from input 402. Thereby, the dimming controller can configure its output level through a sequence of turning on and turning off an existing switch in series with the mains input, without the need for a dimmer switch.

High voltage regulator 408 comprises a circuit configured to regulate the high voltage level across input 402 to a lower voltage level, thereby allowing a dimming controller (not shown) coupled to output 404 to operate. An exemplary voltage level for output 404 is 5 VDC. It would be apparent to one of ordinary skill in the art that the controller power supply can output 3.3 VDC, 9 VDC, or 12 VDC, without departing from the principles disclosed herein.

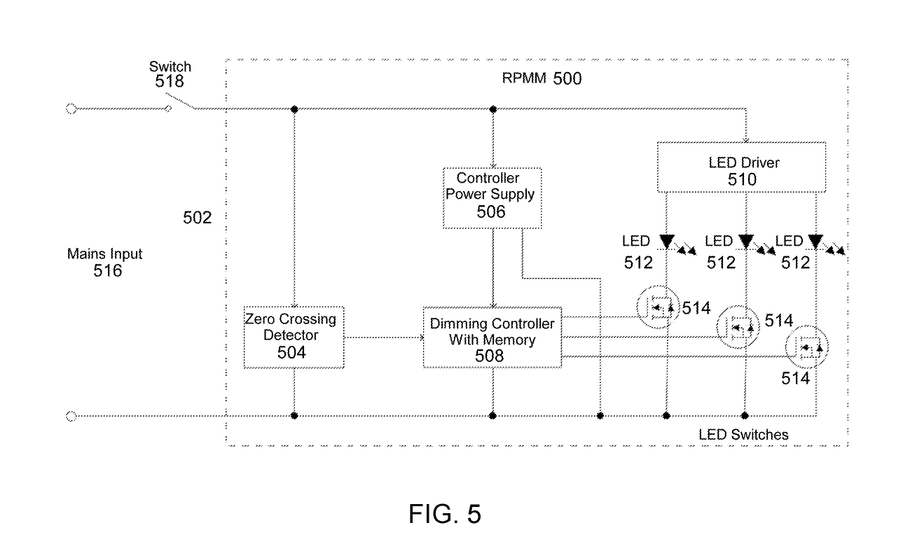

Turning next to FIG. 5, shown is an exemplary block diagram depicting a power control device for an LED lamp in accordance with the principles disclosed herein. In this embodiment, the LED lamp is integrated with RPMM 500. RPMM 500 comprises input 502. As shown, mains input 516 is coupled to input 502. Switch 518 is coupled in series between mains input 516 and input 502 of RPMM 500. In this exemplary embodiment, switch 518 is configured to adjust the output level of the LED lamp by adjusting the plurality of LEDs 512 that are turned on or turned off. Further, as described in detail below with reference to FIGS. 6-8, the output level is selected by a sequence of turning on and turning off switch 518, thereby turning on and turning off the power to input 502 from mains input 516. In this embodiment, switch 518 is an existing wall switch. Therefore, a user can add dimming control functionality in accordance with the principles disclosed herein to an existing wall switch without the need to hire an electrician to replace the existing wall switch.

RPMM 500 further comprises zero crossing detector 504, controller power supply 506, dimming controller 508, and LED driver 510. Zero crossing detector 504 is coupled to dimming controller 508 and configured to transmit a signal when zero crossing detector 504 detects an AC waveform of mains input 516 crosses through zero volts. Mains input 516 can be configured to be 115 VAC to 230 VAC. Dimming controller 508 is configured to detect when switch 518 is turned on and turned off by measuring the length of time that a signal is not received from zero crossing detector 504. Once dimming controller 508 detects a sequence of switch 518 turning on and turning off (as described in detail below with reference to FIGS. 6-8) dimming controller 508 selects an output level to set for the plurality of LEDs 512. For example, dimming controller 508 can select an output level after detecting a sequence of turning on and turning off switch 518 that does not exceed five seconds. Dimming controller 508 further comprises a microprocessor and non-volatile memory. The non-volatile memory of dimming controller 508 is configured to store a plurality of output levels for the plurality of LEDs 512. In this embodiment, the output levels correspond to a low, medium, and high intensity. The non-volatile memory is also configured to store the output level selected by dimming controller 508. Therefore, the selected output level is maintained when switch 518 is turned off for an extended period of time.

As shown in FIG. 5, dimming controller 508 is coupled to a plurality of LED switches 514. LED switch 514 comprises a field-effect transistor (FET). Each LED switch 514 is connected in series to a LED 512. It would be apparent to one of ordinary skill in the art to connect a plurality of LEDs in series to an LED switch, without departing from the principles disclosed herein. Dimming controller 508 is configured to turn on the appropriate plurality of LED switches 514 corresponding to an output level. For example, one LED switch 514 can be turned on to correspond to a low intensity, two LED switches 514 can be turned on to correspond to a medium intensity, and three LED switches 514 can be turned on to correspond to a high intensity.

LED driver 510 comprises a circuit configured to regulate the high voltage level across input 502 to a lower voltage level, thereby allowing the plurality of LEDs 512 coupled to LED driver 510 to operate when a corresponding LED switch 514 is turned on by dimming controller 508. Unlike conventional LED dimmers that adjust the output level by varying the current to all LEDs attached to the LED dimmer, each LED 512 is either turned on or turned off by dimming controller 508 as discussed above for a corresponding output level. As a result, LED driver 510 is configured to provide the appropriate operating current to each LED 512 when turned, thereby eliminating flickering issues. Furthermore, temperature issues are eliminated because fewer LEDs 512 are turned on for a corresponding output level. LED driver 510 further comprises a holdup circuit that allows the plurality of LEDs 512 configured to be turned on by dimming controller 508 to remain on after the high voltage across input 502 is disconnected. Therefore, the LED lamp will not flicker as dimming controller 508 is configured by turning on and turning off the power to input 502 from mains input 516.

In this embodiment, controller power supply 506 is configured to regulate the voltage level across input 502 of RPMM 500 to a voltage level that dimming controller 508 can operate. An exemplary voltage level is 5 VDC. It would be apparent to one of ordinary skill that the controller power supply can output 3.3 VDC, 9 VDC, or 12 VDC, without departing from the principles disclosed herein. Furthermore, controller power supply 506 is configured to provide power to dimming controller 508 for at least five seconds after mains input 516 is removed by turning off switch 518. Thereby, dimming controller 508 can operate while mains input 516 is disconnected from input 502 of RPMM 500. As a result, dimming controller 508 can configure the output level for the plurality of LEDs 512 by a sequence of turning on and turning off switch 518.

FIG. 6 depicts a flowchart representing the process of adjusting the output level of a RPMM in accordance with the principles disclosed herein. First in step 602, the power from a power source coupled to the input of the RPMM is turned on. In step 604, the RPMM outputs power at an output level. In the preferred embodiment, the RPMM comprises three output levels: 30 V, 60 V, and 120 V. Further, the RPMM is initially configured to a default output level of 30 V.

Next, in step 606, the power source coupled to the input of the RPMM is turned off for a period of time and then turned on to configure the output level of the RPMM. In one embodiment, the period of time does not exceed five seconds. Thereafter, in step 608, the output level of the RPMM is adjusted. In the preferred embodiment, the output level is adjusted to the next higher sequential setting, for example 60 V, which would increase the intensity of a bulb attached to the output of the RPMM.

To set the output level to the maximum setting, in step 610, the power source coupled to the input of the RPMM is turned off and then turned on multiple times for a period of time. Thereafter, in step 612, the output level of the RPMM is set to the maximum output level. For example, the power source coupled to the input of the RPMM can be turned off and on three times within a five second period to configure the output level of the RPMM to the maximum output level of 120 V. In some embodiments, the RPMM can be configured such that when the power source coupled to the input of the RPMM is turned off and then turned on, the output level will be configured to the lowest, highest, or any output level. It is also contemplated that when the power source coupled to the input of the RPMM is deactivated in this manner, the output levels will sequence through the same pre-set output values. It is further contemplated that if the power source is terminated at any time in this embodiment, the output of the RPMM device will remain in the off position, thereby terminating any power to the appliance, tool, or device attached to the output of the RPMM.

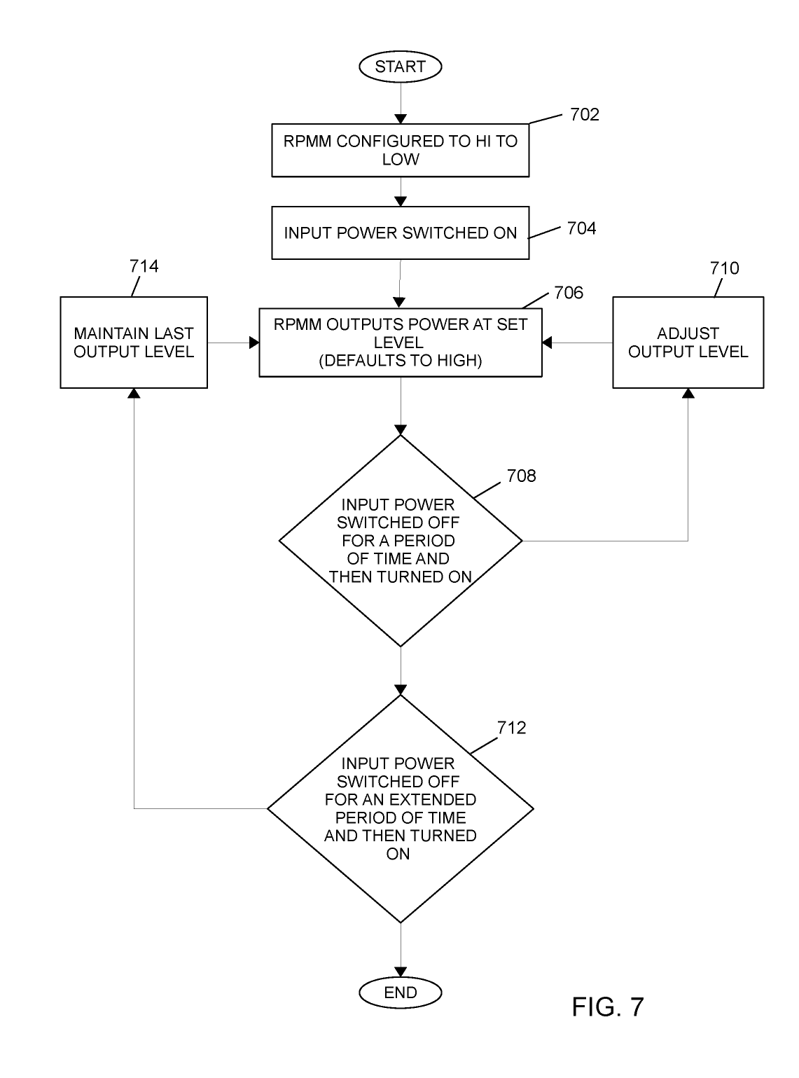

FIG. 7 depicts a flowchart representing the process of adjusting the output level of a RPMM in accordance with the principles disclosed herein. The RPMM device can vary the power intensity of a bulb linearly, e.g., from full intensity to dim, or from a dim setting that gradually increases to full intensity. First, in step 702, the RPMM is configured to HI to LOW. In some embodiments, the RPMM device is set to HI to LOW with a small toggle switch. Next, in step 704, the power from a power source coupled to the input of the RPMM is turned on. In step 706, the RPMM outputs power at an output level. In this embodiment, the default output level is the highest output level.

Next, in step 708, the power source coupled to the input of the RPMM is turned off for a period of time and then turned on to configure the output level of the RPMM. Thereafter, in step 710, the output level of the RPMM is adjusted. In this embodiment, the output level is adjusted to the next lowest sequential output level, which would decrease the intensity of a bulb attached to the output of the RPMM. The process of adjusting the output level in step 710 will cycle the output level from the highest output level to the lowest output level until the power from a power source coupled to the input of the RPMM is turned off for an extended period of time.

To maintain the last output level after the power from a power source coupled to the input of the RPMM is turned off, in step 712, the power is turned on within an extended period of time. For example, the power from a power source coupled to the input of the RPMM is turned on within fifteen seconds. Thereafter, in step 714, the output level of the RPMM is configured to maintain the last output level. Otherwise, when the power from a power source coupled to the input of the RPMM is turned on after the extended period of time, the RPMM device cycles from the highest output level to the lowest output level.

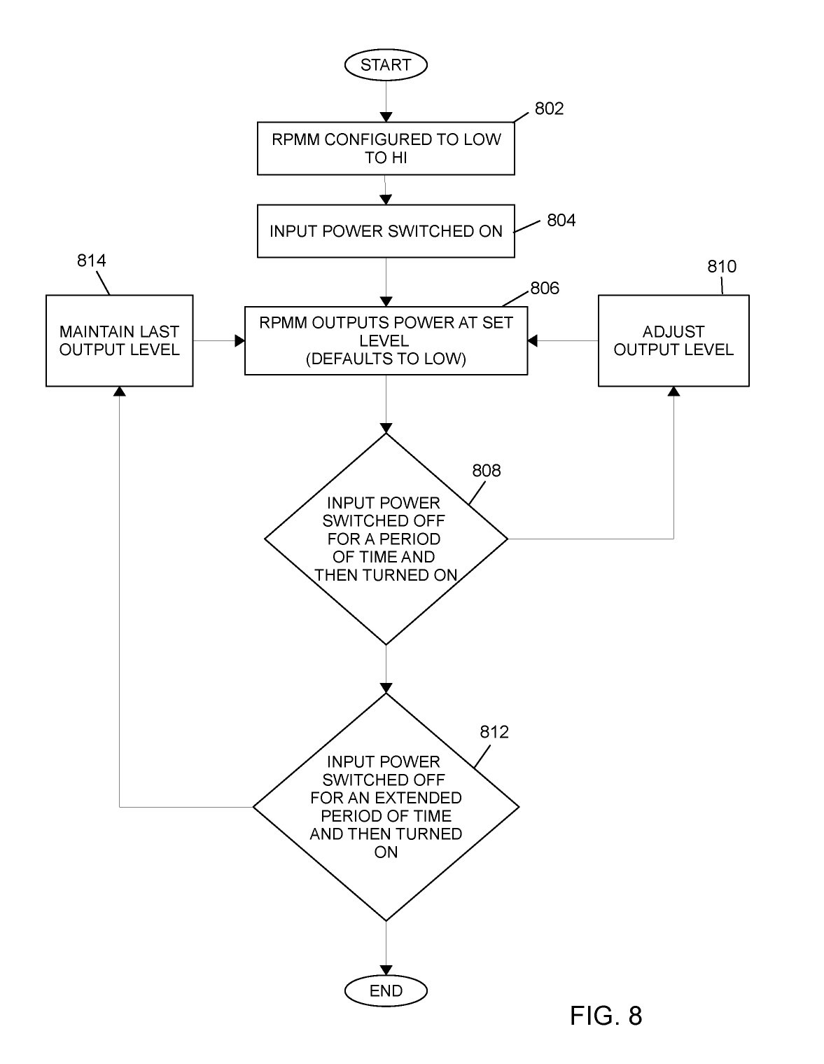

FIG. 8 depicts a flowchart representing the process of adjusting the output level of a RPMM in accordance with the principles disclosed herein. First in step 802, the RPMM is configured to LOW to HIGH. In some embodiments, the RPMM device is set to LOW to HIGH with a small toggle switch on the side of the RPMM device. Next, in step 804, the power from a power source coupled to the input of the RPMM is turned on. In step 806, the RPMM outputs power at an output level. In this embodiment, the default output level is the lowest output level.

Next, in step 808, the power source coupled to the input of the RPMM is turned off for a period of time and then turned on to configure the output level of the RPMM. Thereafter, in step 810, the output level of the RPMM is adjusted. In this embodiment, the output level is adjusted to the next highest sequential output level, which would increase the intensity of a bulb attached to the output of the RPMM. The process of adjusting the output level in step 810 will cycle the output level from the lowest output level to the highest output level until the power from a power source coupled to the input of the RPMM is turned off for an extended period of time.

To maintain the last output level after the power from a power source coupled to the input of the RPMM is turned off, in step 812, the power is turned on within an extended period of time. For example, the power from a power source coupled to the input of the RPMM is turned on within fifteen seconds. Thereafter, in step 814, the output level of the RPMM is configured to maintain the last output level. Otherwise, when the power from a power source coupled to the input of the RPMM is turned on after the extended period of time, the RPMM device cycles from the lowest output level to the highest output level.

In yet another embodiment according to the principles disclosed herein, the RPMM includes a memory function. After a desired output level is reached, the setting can be stored by turning off and then turning on the power from a power source coupled to the input of the RPMM. Thereby, once the power from a power source coupled to the input of the RPMM is turned off, and regardless how long the power is off, once the power is turned on, the output level will be configured to the last stored setting. In one example the stored output level can be cleared by switching the power off and then back on again from a power source coupled to the input of the RPMM.

While the disclosure has been described with reference to the preferred embodiment, which has been set forth in considerable detail for the purposes of making a complete disclosure, the preferred embodiment is merely exemplary and is not intended to be limiting or represent an exhaustive enumeration of all aspects of the broad inventive concepts disclosed herein. It will be apparent to those of skill in the art that numerous changes may be made in such details without departing from the spirit and the principles of the inventive concepts disclosed herein. It should be appreciated that the inventive concepts are capable of being embodied in other forms without departing from their essential characteristics.

What is claimed is:

1. A power control device, comprising:
an input;
an output comprising an output level;
a plurality of output levels;
a microprocessor comprising memory;
wherein a power source is coupled to the input;
wherein a device is coupled to the output;
wherein the output level is selected from the plurality of output levels by turning on and turning off a switch coupled between the power source and the input within a period of time; and
wherein the microprocessor is configured to operate when the switch coupled to the power source is turned off.

2. The power control device of claim 1, wherein the plurality of output levels comprises at least two output levels.

3. The power control device of claim 2, wherein the plurality of output levels comprises 30 Volts, 60 Volts, and 120 V.

4. The power control device of claim 1, wherein the device is an electrical device, application, or tool.

5. The power control device of claim 4, wherein the plurality of output levels corresponds to a speed setting of the electrical device, application, or tool.

6. A power control device, comprising:
an input;
an output;
at least one memory;
a plurality of output levels;
a switch comprising an on position and an off position;
wherein the switch couples a power source to the input;
wherein an output level is selected from the plurality of output levels by turning the switch on and turning the switch off for a period of time;
wherein the at least one memory is configured to store the selected output level; and
wherein a device is coupled to the output.

7. The power control device of claim 6, wherein the plurality of output levels comprises at least two output levels.

8. The power control device of claim 7, wherein the plurality of output levels comprises 30 Volts, 60 Volts, and 120 V.

9. The power control device of claim 6, further comprising a toggle switch comprising a HI-LOW position and a LOW-HI position.

10. The power control device of claim 9, wherein the HI-LO position of the toggle switch configures the output to cycles through the plurality of output levels from a highest output level to a lowest output level.

11. The power control device of claim 6, wherein the device is an electrical device, application, or tool.

12. The power control device of claim 6, wherein the plurality of output levels corresponds to a speed setting of the electrical device, application, or tool.

13. A method comprising the steps of:
configuring a power control device comprising an input, an output, and a plurality of output levels;
coupling a power source to the input of the power control device;
coupling a device to the output of the power control device;
turning on the power source;
selecting an output level from the plurality of output levels by turning on and turning of a switch for a period of time; and
measuring a period of time that the switch is turned off.

14. The method of claim 13, wherein the step of cycling through the plurality of output level of the power control device comprises.
turning off the power source and then turning on the power source within a period of time.

15. The method of claim 13, wherein the step of cycling through the plurality of output level of the power control device comprises.
turning off the power source, turning on the power source, turning off the power source, and then turning on the power source within a period of time.

16. The method of claim 15, further comprising the step of cycling to a higher output level.

17. The method of claim 13, further comprising the step of turning off the output of the power control device.

18. The method of claim 17, wherein the step of turning off the output of the power control device comprises turning off and turning on the power source multiple times within a period to time.

19. The method of claim 18, wherein the step of turning off the output of the power control device comprises:
turning off the power source, turning on the power source, turning off the power source, turning on the power source, and then turning off the power source within a period of time.

20. The method of claim 13, wherein the step of configuring the power control device comprises:
setting the power control device to cycle from a high output level to a low output level.
